(19) United States
(12) Patent Application Publication
(10) Pub. No.: US 2004/0042597 A1
(43) Pub. Date: Mar. 4, 2004

(54) System for automatically billing direct dialed calls to a subscriber designated third party number

(76) Inventors: William Stanley Atkins, Glen Ellyn, IL (US); William Jackson Bushnell, St. Charles, IL (US)

Correspondence Address: PATTON BOGGS, PO BOX 270930, LOUISVILLE, CO, 80027, US

(21) Appl. No.: 10/233,256

(22) Filed: Aug. 30, 2002

(51) Int. Cl. H04M 15/00

(52) U.S. Cl. 379/114.21; 379/114.23; 379/114.26

(57) ABSTRACT

The present system for automatically billing direct dialed calls to a subscriber designated third party number enables a subscriber to generate a list of called numbers, each of which has associated with it a third party billing number. Whenever the subscriber dials a called number from their home location, the Local Exchange Carrier automatically compares the direct dialed number with the numbers stored on this list. If the Local Exchange Carrier identifies a match, the charges for the direct dialed call are automatically and directly billed to the third party number on the list. The list is typically stored and managed by an Alternate Billing Server maintained by the third party but can also be stored and managed by the Local Exchange Carrier or the Inter-Exchange Carrier.

### FIELD OF THE INVENTION

This invention relates to Local Exchange Carriers and to a system that enables a subscriber to designate third party billing numbers for direct dialed calls made to predetermined called numbers.

### PROBLEM

It is a problem for subscribers who work from a home office or remote location to bill their telephone calls to the appropriate telephone numbers. These subscribers typically either have a dedicated business line or they use their standard residential line for use in their home office. The calls can be direct dialed with the billing reconciled upon receipt of the monthly bill, or a corporate telephone credit card or 800-number can be used for immediate billing reconciliation.

If the subscriber uses their residential line for business calls, the monthly charges for calls made to all destinations are billed to the residential line and the subscriber must account for the individual calls made to business destinations once the monthly bill is received. This is a time consuming process. If the subscriber's work location is equipped with a separate business line, the monthly charges for calls made by a subscriber are billed to the business line but the subscriber must typically still account for the individual calls that are made to various destinations once the monthly bill is received.

Telephone calls can alternatively be made by the subscriber by using a corporate telephone credit card, or by using a business 800-number. These calls typically require the use of additional dialed information to identify the account to which the call is charged are more therefore not only more expensive but are also more cumbersome to dial than direct dialed calls. For a subscriber who originates frequent calls to the home office to check voice mail or to communicate with co-subscribers located in the office, this process is unduly tedious and expensive.

Another aspect of this problem relates to the division of revenues among the carriers. On credit card and 800-number based toll calls, the revenues are divided between the Local Exchange Carrier (LEC) and the Inter-Exchange Carrier (IXC). Frequently, a calling card or 800-number service is provided on a contract basis from an Inter-Exchange Carrier, with even Intra-LATA toll calls being handled by the Inter-Exchange Carrier. On these calls, most of the revenues are paid to the Inter-Exchange Carrier, with the Local Exchange Carrier being compensated exclusively for access charges. Thus, the Local Exchange Carrier fails to obtain the toll revenue that they would normally receive on these calls.

Thus, there is no system presently available that enables a subscriber to have their direct dialed calls automatically billed to predetermined designated numbers, absent the use of additional dialing codes for a corporate telephone credit card, or by using a business 800-number.

### SOLUTION

The above-described problems are solved and a technical advance is achieved by the present system for automatically billing direct dialed calls to a subscriber designated third party number which enables a subscriber to generate a list of called numbers, each of which has associated with it a third party billing number. Whenever the subscriber dials a called number from their home location, the Local Exchange Carrier automatically compares the direct dialed number with the numbers stored on this list. If the Local Exchange Carrier identifies a match, the charges for the direct dialed call are automatically and directly billed to the third party number on the list. The list is typically stored and managed by an Alternate Billing Server maintained by the third party but can also be stored and managed by the Local Exchange Carrier or the Inter-Exchange Carrier.

The third party must approve the inclusion of their number on the subscriber's list. This can be effected by prior written approval or by use of a server maintained by the third party which can be queried on a per call basis. This latter method enables the third party to maintain control of the billing process and to rapidly change the authorizations for call billing.

### BRIEF DESCRIPTION OF THE DRAWINGS

FIG. 1 illustrates, in block diagram form, the present system for automatically billing direct dialed calls to a subscriber designated third party number as implemented in a typical telephone communication network environment;

FIG. 2 illustrates a typical subscriber table of called numbers and third party billing numbers used by an Alternate Billing Server to initiate automated billing of a call to a third party number;

FIG. 3 illustrates a typical subscriber table of Alternate Billing Servers maintained by the Service Control Processor to enable the Service Control Processor to locate the subscriber's billing tables; and

FIG. 4 illustrates, in flow diagram form, the operation of the present system for automatically billing direct dialed calls to a subscriber designated third party number.

### DETAILED DESCRIPTION

The present system for automatically billing direct dialed calls to a subscriber designated third party number enables a subscriber to generate a list of called numbers, each of which has associated with it a third party billing number. Whenever the subscriber dials a called number from their home location, the Local Exchange Carrier automatically compares the direct dialed number with the numbers stored on this list. If the Local Exchange Carrier identifies a match, the charges for the direct dialed call are automatically and directly billed to the third party number on the list.

Telephone Communication Network Environment

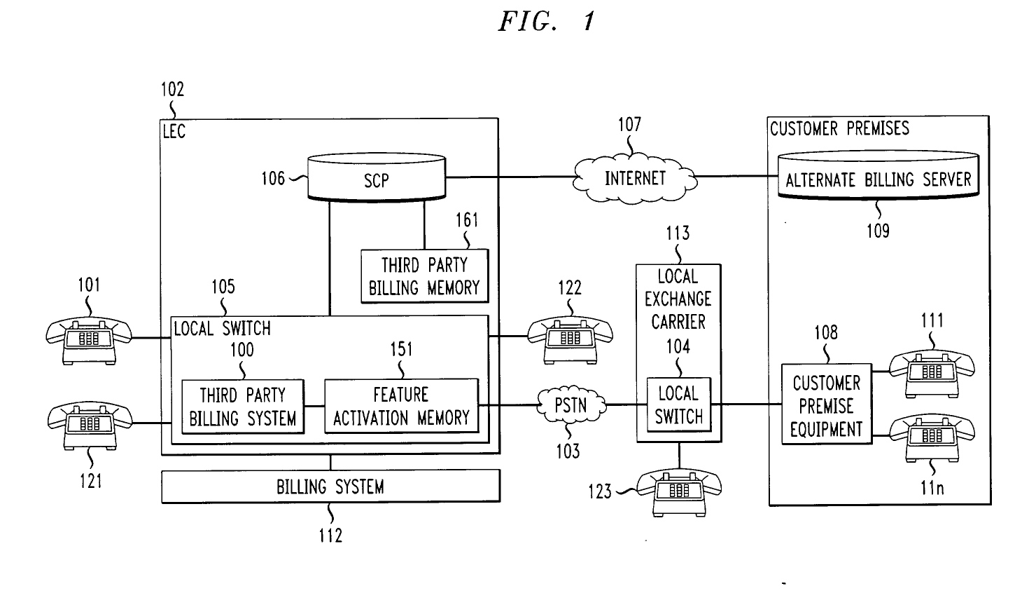

FIG. 1 illustrates, in block diagram form, the present system for automatically billing direct dialed calls to a subscriber designated third party number 100 as implemented in a typical telephone communication network environment. In this environment, a subscriber who works for a particular business from a home or remote location is equipped with a telephone station set 101 that is served by a Local Exchange Carrier 102. The Local Exchange Carrier 102 connects the subscriber line that serves the telephone station set 101 to a local switch 105 in conventional fashion. The Local Exchange Carrier 102 includes a Service Control Processor 106 which serves the local switch 105 and which is connected to an IP Network 107, such as the Internet. The local switch 105 is also connected to and served by a billing system 112, which may be part of the Local Exchange Carrier 102, and an Inter-Exchange Carrier 103 network which connects the local switch 105 to other local switches 104 maintained by other Local Exchange Carriers 113. The business which employs the subscriber is shown as having an office, which is served by a local switch 104 operated by another Local Exchange Carrier 113. The business' office is typically equipped with a plurality of telephone station 111-11n sets and may be served by customer premise equipment 108 that interconnects the plurality of telephone station sets 111-11n to the local switch 105 via trunks. The customer premise equipment 108 is typically assigned a Listed Directory Number (LDN) and each of the plurality of telephone station sets 111-11n is assigned an extension number based on the Listed Directory Number, which extension number may be used for direct dial access of the associated telephone station set. A number of additional telephone station sets 121-123, served by the local switches 104, 105, are also shown and these telephone station sets 121-123 represent destinations called by the subscriber on a regular basis and therefore are included in the service provided by the present system for automatically billing direct dialed calls to a subscriber designated third party number.

A business establishes an account with a Local Exchange Carrier 102 or the Inter-Exchange Carrier 103 to manage the billing of calls made by a predetermined subscriber, using their assigned subscriber line, which has a predetermined telephone number, such as (630) 377-1111. In implementing this service, the business typically activates an Alternate Billing Server 109 to perform the database maintenance function, although the Local Exchange Carrier 102 may provide the database. In any case, the Alternate Billing Server 109 contains a database of the telephone numbers of the remotely located subscribers employed by the business and the called numbers that these subscribers can dial. Each subscriber can have their own unique list of numbers that they can dial and third party identifications for call billing. Even though more than one subscriber can dial the same number, the billing number can be different for the two subscribers. This enables the business to track expenses on a per employee basis.

Automatically Billing of Direct Dialed Calls

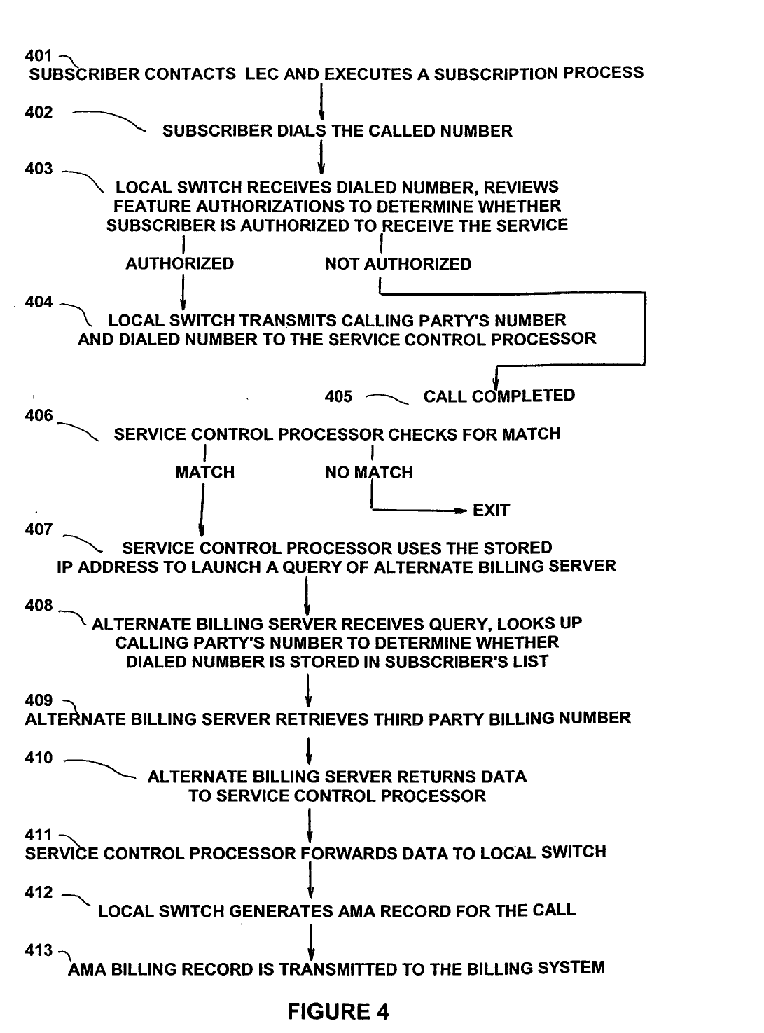

FIG. 4 illustrates, in flow diagram form, the operation of the present system for automatically billing direct dialed calls to a subscriber designated third party number 100. For a subscriber to initiate service, at step 401 they contact the Local Exchange Carrier 102 or the Inter-Exchange Carrier 103 and execute a subscription process where they subscribe to this service, specify the IP address of the Alternate Billing Server 109, and specify the called numbers. This information is stored in the Service Control Processor 106 (SCP) of the Local Exchange Carrier 102. This centralized database enables the subscribers to securely bill their calls to third party numbers from remotely located sites. The business can alternatively generate the data entries for this table.

In operation, the subscriber at subscriber line (630) 377-1111 originates a call by going off hook and dialing the called number, such as (847) 290-4321 at step 402. The local switch 105 in the Local Exchange Carrier 102 receives the dialed number and reviews at step 403 the feature authorizations of the subscriber line to determine whether the subscriber is authorized to receive the service. This is accomplished by the local switch 105 reviewing feature activation data stored in a feature activation memory 151 to locate an entry corresponding to the subscriber line. The feature activation data identifies the services authorized for the subscriber line. If the subscriber is authorized to receive the third party billing service, the local switch at step 404 transmits both the calling party's number (630) 377-1111 and the dialed number (847) 290-4321 to the Service Control Processor 106. If the service is not authorized, the call is placed in conventional fashion at step 405. The Service Control Processor 106 upon receipt of these numbers checks at step 406 the third party database that is stored in a third party server identification memory 161 to determine whether a match is located in the database.

FIG. 3 illustrates a typical subscriber table of Alternate Billing Server identification data that is maintained by the Service Control Processor 106 to enable the Service Control Processor 106 to locate the subscriber's billing tables. If a match is determined, this indicates that the subscriber line is authorized to receive third party billing for the dialed number and the stored IP address identifies the third party's Alternate Billing Server 109. In response to this determination, the Service Control Processor 106 at step 407 uses the stored IP address, such as 135.3.19.120, to launch a query of the Alternate Billing Server 109. The query typically includes both the calling party's number, the called number, and the IP address of the Service Control Processor 106 that originated the query. The Alternate Billing Server 109 receives the query at step 408, looks up the calling party's number to determine whether the dialed number is stored in the list for this subscriber.

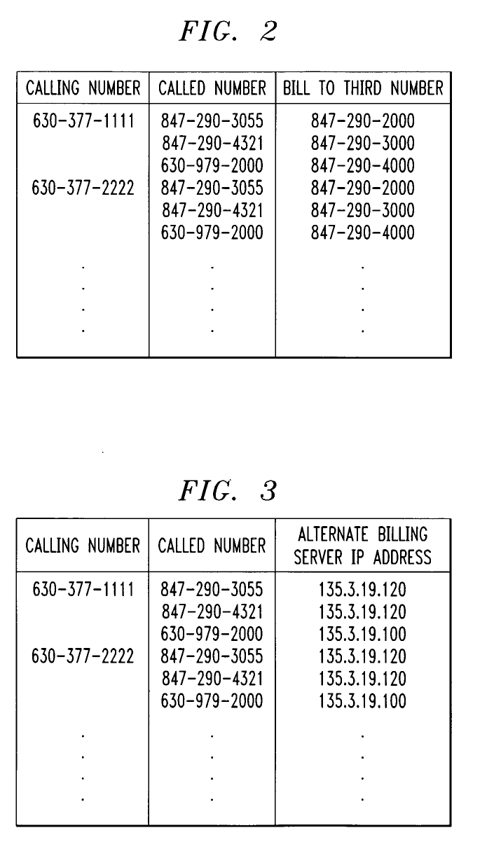

FIG. 2 illustrates a typical subscriber table of called numbers and third party billing numbers used by an Alternate Billing Server 109 to initiate automated billing of a call to a third party billing number. If the dialed number is stored in the list for this subscriber, at step 409 the Alternate Billing Server 109 retrieves the pre-authorized third party billing number, such as (847) 290-3000, from the database and at step 410 returns this value to the Service Control Processor 106 (using the IP address of the Service Control Processor 106 received in the query) along with the calling party's number and the dialed number. The Service Control Processor 106 at step 411 forwards the data to the local switch, which generates an Automatic Message Accounting (AMA) record for the call at step 412, which lists the calling party's number, the dialed number, and the third party's billing number. The AMA billing record is transmitted to the billing system at step 413 which determines the toll charges for the call and adds the charges for this call to the monthly bill for the designated bill to third party billing number.

### SUMMARY

The system for automatically billing direct dialed calls to a subscriber designated third party number enables a subscriber to generate a list of called numbers, each of which has associated with it a third party billing number. Whenever the subscriber dials a called number from their home location, the Local Exchange Carrier automatically compares the direct dialed number with the numbers stored on this list. If the Local Exchange Carrier identifies a match, the charges for the direct dialed call are automatically and directly billed to the third party number on the list.

What is claimed:

1. A method, operable in a telecommunications system, for automatically billing calls directly dialed from a subscriber line to a subscriber designated third party number, comprising:
determining, in response to receipt of a call origination on said subscriber line and from feature activation data stored in a feature activation memory, that said subscriber line is authorized to receive third party billing of calls originated from said subscriber line;
comparing a telephone number dialed in said call origination to a table containing at least one called telephone number stored for said subscriber line and indicative of called telephone numbers included in the service provided by said authorized third party billing of calls originated from said subscriber line;
retrieving a third party billing number from a third party billing memory upon occurrence of a match of said dialed number and a one of said at least one of called number stored for said subscriber line; and
generating a billing record to bill the cost of the originated call to said retrieved third party billing number.

2. The method for automatically billing direct dialed calls to a subscriber designated third party number of claim 1 further comprising:
storing feature activation data in said feature activation memory indicative of an identity of said subscriber and authorization by said third party to enable billing of call originations to said third party billing number for the called telephone numbers included in the service provided by said authorized third party billing of calls originated from said subscriber line.

3. The method for automatically billing direct dialed calls to a subscriber designated third party number of claim 2 further comprising:
storing a third party billing number in said third party billing memory, wherein said third party billing number comprises a number from the class of billing numbers comprising: telephone numbers, account numbers.

4. The method for automatically billing direct dialed calls to a subscriber designated third party number of claim 1 further comprising:
generating data entries for said table, each data entry containing at least one called telephone number stored for said subscriber line and indicative of called telephone numbers included in the service provided by said authorized third party billing of calls originated from said subscriber line.

5. The method for automatically billing direct dialed calls to a subscriber designated third party number of claim 1 further comprising:
receiving data from said third party indicative of authorization to enable billing of call originations to said third party billing number for the data entries generated for said table.

6. The method for automatically billing direct dialed calls to a subscriber designated third party number of claim 1 further comprising:
transmitting said billing record to a billing system upon completion of said call origination.

7. The method for automatically billing direct dialed calls to a subscriber designated third party number of claim 1 wherein said step of comparing comprises:
retrieving data from a third party server identification memory indicative of an IP address of a server that contains said table; and
transmitting a query to said server via said IP address to determine whether said table contains an entry corresponding to said called telephone number.

8. The method for automatically billing direct dialed calls to a subscriber designated third party number of claim 7 wherein said step of comparing further comprises:
receiving a response from said server indicative that said table contains an entry corresponding to said called telephone number.

9. A system, operable in a telecommunications system, for automatically billing calls directly dialed from a subscriber line to a subscriber designated third party number, comprising:
service determining means, responsive to receipt of a call origination on said subscriber line and from feature activation data stored in a feature activation memory, that said subscriber line is authorized to receive third party billing of calls originated from said subscriber line;
database query means for comparing a telephone number dialed in said call origination to a table containing at least one called telephone number stored for said subscriber line and indicative of called telephone numbers included in the service provided by said authorized third party billing of calls originated from said subscriber line;
data retrieval means for retrieving a third party billing number from a third party billing memory upon occurrence of a match of said dialed number and a one of said at least one of called number stored for said subscriber line; and
call record means for generating a billing record to bill the cost of the originated call to said retrieved third party billing number.

10. The system for automatically billing direct dialed calls to a subscriber designated third party number of claim 9 further comprising:
subscriber identification means for storing feature activation data in said feature activation memory indicative of an identity of said subscriber and authorization by said third party to enable billing of call originations to said third party billing number for the called telephone numbers included in the service provided by said authorized third party billing of calls originated from said subscriber line.

11. The system for automatically billing direct dialed calls to a subscriber designated third party number of claim 10 further comprising:
billing identification means for storing a third party billing number in said third party billing memory, wherein said third party billing number comprises a number from the class of billing numbers comprising: telephone numbers, account numbers.

12. The system for automatically billing direct dialed calls to a subscriber designated third party number of claim 9 further comprising:
database entry means for generating data entries for said table, each data entry containing at least one called telephone number stored for said subscriber line and indicative of called telephone numbers included in the service provided by said authorized third party billing of calls originated from said subscriber line.

13. The system for automatically billing direct dialed calls to a subscriber designated third party number of claim 9 further comprising:
message receiving means for receiving data from said third party indicative of authorization to enable billing of call originations to said third party billing number for the data entries generated for said table.

14. The system for automatically billing direct dialed calls to a subscriber designated third party number of claim 9 further comprising:
billing transmission means for transmitting said billing record to a billing system upon completion of said call origination.

15. The system for automatically billing direct dialed calls to a subscriber designated third party number of claim 9 wherein said database query means comprises:
address retrieval means for retrieving data from third party server identification memory indicative of an IP address of a server that contains said table; and
query generation means for transmitting a query to said server via said IP address to determine whether said table contains an entry corresponding to said called telephone number.

16. The system for automatically billing direct dialed calls to a subscriber designated third party number of claim 15 wherein said database query means further comprises:
response processing means for receiving a response from said server indicative that said table contains an entry corresponding to said called telephone number.
